(19) United States
(12) Patent Application Publication
(10) Pub. No.: US 2016/0012534 A1
(43) Pub. Date: Jan. 14, 2016

(54) SYSTEM AND METHOD FOR ACTIVE PARTICIPATION IN AN INVESTOR-MANAGED CORPORATION

(71) Applicant: Darrell Hubbard, Beverly Hills, CA (US)

(72) Inventor: Darrell Hubbard, Beverly Hills, CA (US)

(21) Appl. No.: 14/690,624

(22) Filed: Apr. 20, 2015

Related U.S. Application Data
(60) Provisional application No. 61/981,958, filed on Apr. 21, 2014.

(51) Int. Cl. G06Q 40/06; G06Q 10/00

(52) U.S. Cl. CPC G06Q 40/06; G06Q 10/00

(57) ABSTRACT

A method comprises receiving a proposal from a lead investor of an investor-managed partnership corporation. The proposal is received over a network communication system. The proposal at least comprises voting options. The proposal is stored in a database of a securities compliant active participation system. The receipt of the proposal is communicated to voting investors of the investor-managed partnership corporation for initiating a voting process. Voting data is received for each of the voting investors. A voting power weight of each of the voting investors is added to voting data in a cumulative manner for each of the voting options. A highest weighted cumulative voting option is stored as a decision.

### CROSS-REFERENCE TO RELATED APPLICATIONS

The present Utility patent application claims priority benefit of the U.S. provisional application for patent Ser. No. 61/981,958 entitled “Federal and State Securities Exemption Compliance System for Member-Managed Corporations” filed on 2014 Apr. 21 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to buying and selling investment securities. More particularly, the invention relates to validating investment bids from the general public by ensuring their investments are either exempt from securities laws, or their investment are compliant with securities laws. The invention also relates to implementing active participation in an investor-managed corporation.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that Federal Securities Laws are regulated by the Security and Exchange Commission (SEC). State Securities Laws are regulated by different Regulators within each of the States. Securities regulations are designed to protect the general public by providing investment guidelines to companies seeking to raise investment capital or sell investment products. An investment is considered either exempt from Securities regulation, or is considered non-exempt and must be registered with the proper Federal and/or State regulatory authority.

Traditionally, raising investment money occur offline with limited or no general solicitation to the public. Most recently, the SEC and some State Regulators are allowing general solicitation to the public for Securities targeting both Unaccredited and Accredited Investors. Accredited investors are investors who are considered wealthy and could fend for themselves in making an investment decision.

There are generally a multitude of Securities Exempt laws at both the Federal and State level. And many of the State exemption laws conflict, overlap, and could be vastly different. The same exists for non-exempt Securities. Generally, a company seeking to raise investment dollars would determine their specific securities exempt or non-exempt regulation and target investors specifically that would not violate their governing regulatory statutes.

With the introduction of online investing, such as peer-to-peer lending and Crowdfunding for equity web portals, buying and selling of investment grade securities will become significantly impacted. With investors geographically dispersed across judicial territories, there exists a need for ensuring investment web portals are compliant with applicable Federal and State securities laws for their investment offering. Control systems must be in place to ensure proposed investments by general public investors do not violate any applicable Federal or State regulation governing the investment offer.

Securities regulation is designed to protect passive investors who rely on the efforts of others to make a profit. Federal Securities Exemption law does not consider an investment a Security if the investor is actively involved in the operations of an investor-managed partnership. With investors being geographically dispersed across State lines, Investor-managed partnerships participating in investments may need to find ways to adhere to this Federal Securities exemption qualification. Traditional options generally require a local presence to demonstrate active participation. An online solution which could streamline and satisfy the active participation requirement would be desirable.

In view of the foregoing, it is clear that these traditional techniques are not perfect, and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of a high-level architecture of an exemplary securities investment compliance system (SICS), in accordance with an embodiment of the present invention;

FIG. 2 is an illustration of an exemplary logical data model of a securities compliant bid validation system, in accordance with an embodiment of the present invention;

FIG. 2a is an illustration of an exemplary data dictionary of a securities compliant bid validation system, in accordance with an embodiment of the present invention;

FIG. 3 is an illustration of an exemplary system for implementing securities compliant bid validation, in accordance with an embodiment of the present invention;

FIG. 4 is an illustration of an exemplary method for implementing a securities exemptions compliance bid validation system;

FIG. 5 is an illustration of an exemplary conceptual application architecture for implementing securities compliant search and matching system, in accordance with an embodiment of the present invention;

FIG. 6 is an illustration of an exemplary method for implementing a securities exemptions compliance search and matching system, in accordance with an embodiment of the present invention;

FIG. 7 is an illustration of an exemplary logical data model of a securities exemption compliant active participation system, in accordance with an embodiment of the present invention;

FIG. 8 is an illustration of an exemplary conceptual application architecture for automating an active participation system, in accordance with an embodiment of the present invention;

FIG. 9 is an illustration of an exemplary method for implementing an active participation system, in accordance with an embodiment of the present invention;

FIG. 10 is a block diagram depicting an exemplary client/server system which may be used by an exemplary web-enabled/networked embodiment of the present invention; and

FIG. 11 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments may be suitable for allowing investors to purchase investment units over an internet connection or other distributed communications network. In some embodiments, investors may access a server which may include a database containing information pertaining to investment offers. In some of these embodiments, an investor may view details on the investment offer, make and investment bid on the said investment offer, and receive and accept or reject response from the server on their proposed investment.

In some of these embodiments, investors may enter personal profile information, such a domicile territory and/or financial information, and invoke a search feature to browse or view investment offers where there investment would not violate securities regulatory laws governing the investment offer.

Some embodiments may be suitable for allowing investors to actively participate in a group over an internet connection or other distributed communications network. In some embodiments, investors may access a server which may include a database containing information pertaining to decision to be made by a group. In some of these embodiments, investors may enter proposals requiring group decision into the database, and investors may vote on the proposals to formulate a highest weighted preference for making a group decision. In a non-limiting example, a proposal may contain a headline and/or brief summary of an issue or decision to be made, such as, “Should we accept this offer from XYZ of $500,000?” In another non-limiting example, a vote may be a set of one or more non-mutually exclusive actions to be decided by a group in response to a proposal, such as, “(a) Accept the offer, (b) Don't Accept the Offer.”

In some embodiments, proposals may have parent identifiers. In a non-limiting example, a parent proposal may be a proposal previously decided by a group which may have resulted in a child proposal. In some embodiments, all proposals may have a parent proposal except for a root proposal. In some of these embodiments, a root proposal may be a fundamental proposal from which a group may be founded. In a non-limiting example, a root proposal may be, “Should we incorporate a partnership to buy this house for $300,000?” In some embodiments, there may be one or multiple subsequent proposals and decisions which may stem from a root proposal. In some of these embodiments, subsequent proposals and decisions may further stem from second level proposals (subsequent proposals from a root proposal), and so on, to create a decision tree for a group. In a non-limiting example, a root proposal may be, “Should we form an LLC partnership?”, and a decision tree from the root proposal may be, “Should we form an LLC partnership?; should we buy this house for $200,000?; should we fix it up for $40,000?; and should we sell it for $300,000?”

In many embodiments, a system may be suitable for receiving and/or posting data from investors which may assist other investors in deciding on proposals through voting on actions. In some embodiments, investors may post and/or access reference documents to review in consideration of voting on actions in response to proposals. In other embodiments, investors may post and/or access URL links of web pages which may contain information relating to and/or impacting a proposal and/or action in response to a proposal. In some embodiments, investors may post and/or view requests for information (RFI) regarding proposals. In a non-limiting example, a user may ask, “Could I see their credit report?” In some of these embodiments, investors may respond to RFIs by uploading documents into a “documents section” for some or all investors to review. In some embodiments, investors may post and/or view costs, or a qualitative or measurable value which may indicate financial and/or related costs of implementing a proposal and/or action of a proposal. In other embodiments, investors may post and/or view risks, or a qualitative or measureable value which may indicate potential financial and/or related risks of not implementing a proposal and/or action of a proposal. In some embodiments, investors may create and/or view a timeline which may show an estimate of a timeline which may be required to implement a proposal and/or action of a proposal. In other embodiments, investors may post and/or view benefits, or a qualitative or measurable value which may indicate potential financial and/or related benefits of implementing a proposal and/or action of a proposal. In some embodiments, investors may post and/or view financial statements which may illustrate financial impact of implementing a proposal and/or action of the proposal. In a non-limiting example, exemplary financial statements may include, without limitation, income statements and balance sheets. In some embodiments, a proposal may have an expiration date, by which date investors of a group may vote on an action in response to the proposal. In some of these embodiments, system may have a default response which may be applied to investors who do not respond by an expiration date. In some embodiments, investors may create and/or view proposal blogs, which may be a discussion on an open proposal which other investors may comment. In many embodiments, investors may have variable voting power. In some of these embodiments, a decision may be a chosen action from investor voting based on the accumulated weighted voting power of all investors by action, and a highest weighted voted action may become the group's official decision to the proposal.

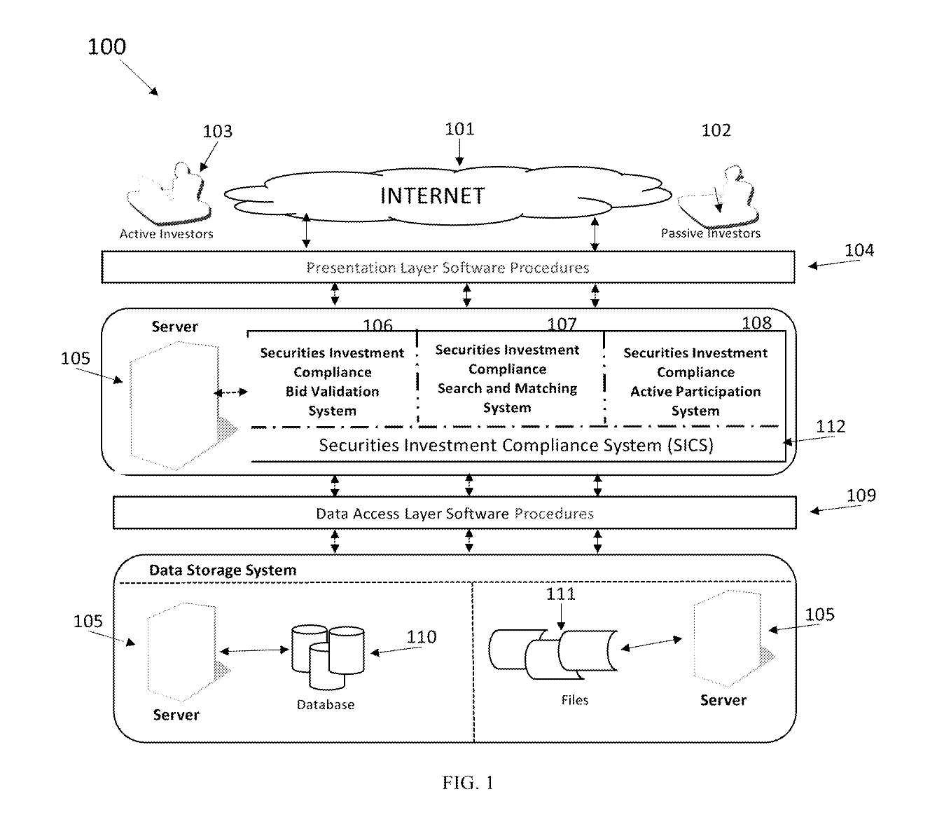

FIG. 1 is an illustration of a high-level architecture of an exemplary securities investment compliance system (SICS) 100, comprising modules for implementing a securities compliant bid validation system 106, a securities compliant search and matching system 107, and for implementing a securities exemption active participation system 108, in accordance with an embodiment of the present invention;

In the present embodiment, users are potential or current passive investors 102 or potential or current active investors 103 in an investment opportunity. Active investors 102 actively participate in decision-making and other communications through use of internet 101 or other distributed communication network. In some embodiments, users may access internet 101 through use of any suitable device, including, without limitation, desktop computer, laptop, tablet, smartphone, etc. In one embodiment, one or more users may be designated as lead investors 103 during communications between other active co-investors 102. In the present embodiment, system may have a server 105. In the present embodiment, system may have a data access layer interface with one or more data access modules 109 which may be suitable for communicating with one or more data sources. In some embodiments, server may comprise a database 110 which may store and retrieve information pertaining to the securities investment compliance system (SICS) 112. In some of these embodiments, the server may also comprise a set of files 111 which may store and retrieve information pertaining to the SICS 112. In the present embodiment, system may have a presentation layer interface with one or more presentation modules 104 which may be suitable for displaying various data and soliciting and receiving various input data from users across the system 112. In the present embodiments, the server may comprise mutually exclusive application modules for implementing a securities investment compliance system (SICS) 112. In many embodiments, the securities investment compliance system may comprise an application module for automating a securities investment compliant bid validation system 106. In some of these embodiments, the securities investment compliance system may have an application module for implementing a securities compliant search and matching system 107.

In many embodiments, the securities investment compliance system may comprise an application module for implementing a system for automating a securities exemption of active participation 108.

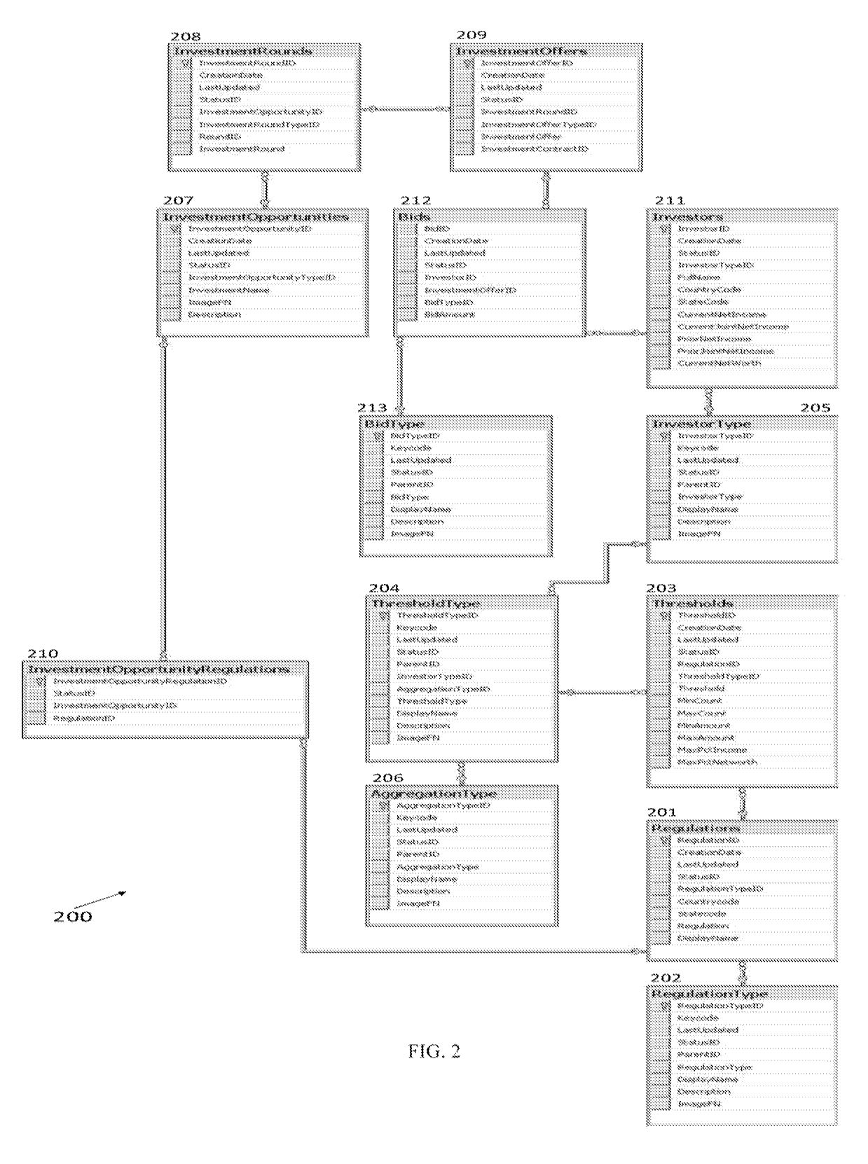

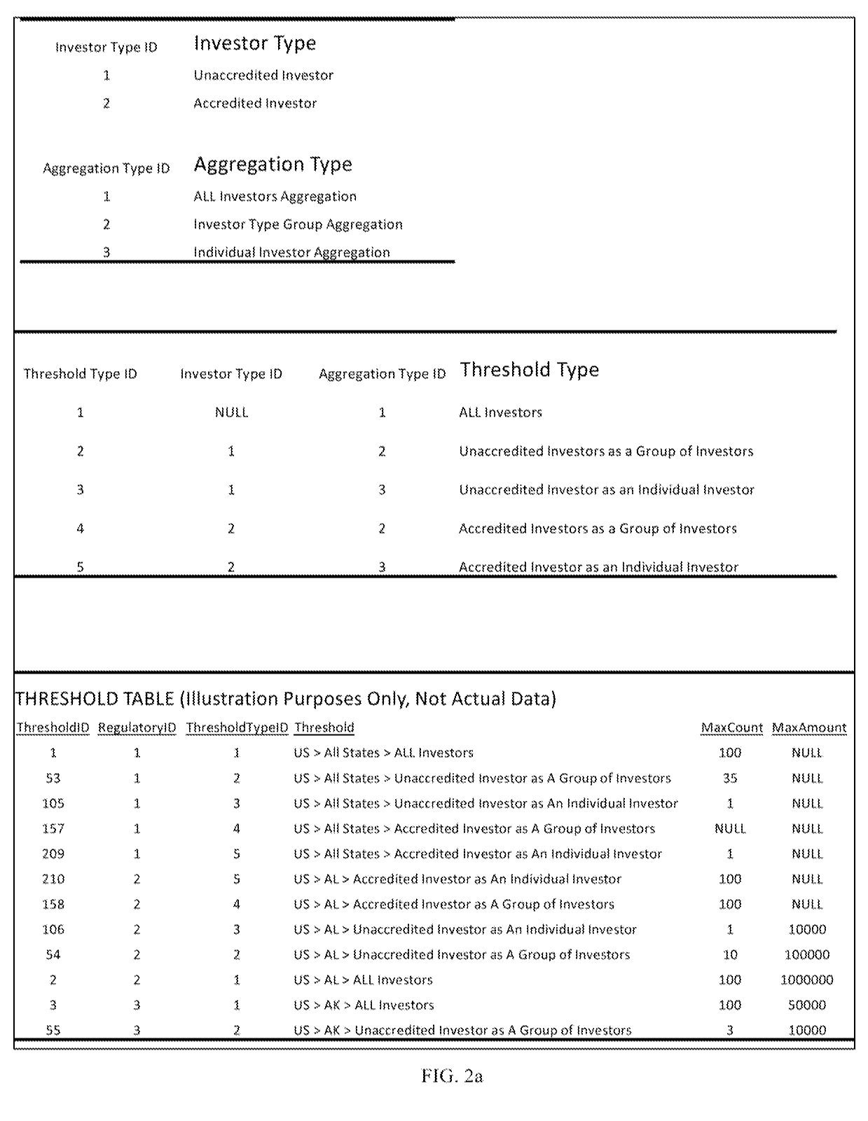

FIG. 2 is an illustration of an exemplary logical data model 200 of a securities compliant bid validation system 106, in accordance with an embodiment of the present invention. In the present embodiment, a logical data model 200 may be composed of a variety of data sets pertaining to, without limitation, securities regulations 201, category classes of regulations compliance 202, regulatory thresholds 203, types of regulatory thresholds 204, investor types associated with regulatory thresholds 205, and aggregation types associated with regulatory thresholds 206, investment opportunities 207, regulations governing an investment opportunity 210, rounds of investments 208 offers associated with investment opportunities 207, investment offers 209 associated with investment rounds 208, investors 211, the type of investors as defined by Regulators 205, investor bids 212, and type of bids 213. The regulations data set 201 comprises a listing of one or more securities regulations enacted into law, wherein each regulation 207 is represented by a unique identifier. The regulation type data set 202 comprises a listing of each class of regulation such as securities exemption regulation, and non-exemption securities regulation, wherein each regulation type is represented by a unique identifier. The thresholds data set 203 comprises a set of one or more thresholds for each regulatory rule 201, wherein each threshold set 203 is represented by a unique identifier. Each threshold set 203, comprises threshold type 204 which further comprises an investor type identifier and an aggregation type identifier. The investor type data set 211 comprises a listing of all the type of investors as defined by the regulations 201. And the aggregation type data set 206, defines the level of aggregation summation to apply to the bid data 212 associated with an investment opportunity to determine securities compliance qualification. The investment opportunities data set 207 comprises a listing of all the investment opportunities available for investment, wherein each investment opportunity 207 is represented by a unique identifier. The investment round data set 208, defines the current investment round associated with the investment opportunity 207, wherein each investment round 208 is represented by a unique identifier. The investment offers data set 209 comprises all of the investment offers available within an investment round 208, wherein each investment offer 209 is represented by a unique identifier. The investment opportunity regulations data set 210 comprises a set of regulations 201 governing an investment opportunity 207, wherein each investment opportunity regulation 210 is represented by a unique identifier.

The investor data set 211 comprises domicile territory and investor financial data elements pertinent for deriving the investor type 205 and for deriving the judicial territory applicable to the investor in data formats computationally equivalent with the investor type and domicile territories governed in the regulations 201. These assigned or derived data elements in the investor data set 211 are essential for validating bids and for searching and matching investors with investment opportunities 207 where their bid 212 into the investment opportunity 207 would not violate any regulatory threshold requirements 203 for an investment offer 209. In the present embodiment, the investor data set 211 comprises the investor's domicile country and state, their earnings income for the past two years, their joint earning income with their spouse for the past two years, their net worth, their investment budget, and their derived investor type 205, wherein each investor 211 is represented by a unique identifier. In some embodiments, one or more of the investor profile data set 211 elements may be derived, defaulted, or not be included in the validation bid or the search and matching algorithm. The bids data set 212 comprises the bid amount an investor 211 has proposed on an investment offer 209, wherein each bid 212 is represented by a unique identifier.

FIG. 2a is an illustration of an exemplary data dictionary of a securities compliant bid validation system, in accordance with an embodiment of the present invention.

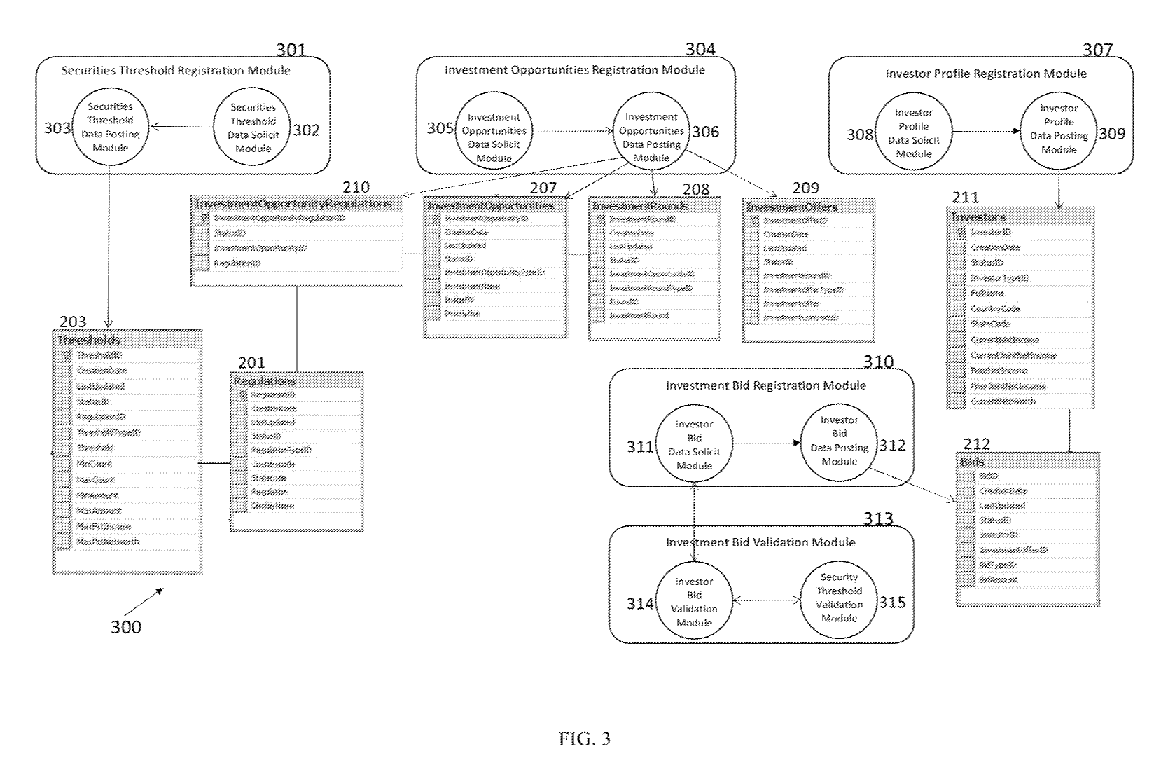

FIG. 3 is an illustration of an exemplary system for implementing securities compliant bid validation, in accordance with an embodiment of the present invention. In the present embodiment, an securities threshold registration module 301 comprising an securities threshold data solicit module 302 and an securities threshold data posting module 303 receives and posts securities threshold data 203 to the database 110. In many embodiments, the securities threshold data solicit module 302 may be configured to receive one or more regulated securities threshold data sets 203 and the securities threshold data posting module 303 may be configured to post securities threshold data 203 into the database 110. In some of these embodiments, an securities threshold data set solicit module 302 may solicit, without limitation, the applicable government regulation 201 associated with the threshold set 203, a threshold type 204, and one or more threshold boundary values each representing a distinct threshold attribute and validation test comprising the threshold set 203. In the present embodiment, an investment opportunity registration module 304 comprising an investment opportunity data solicit module 305 and an investment opportunity data posting module 306 receives and posts investment opportunity data sets 207 to the database 110. In many embodiments, the investment opportunity data solicit module 305 may be configured to receive one or more investment opportunity data sets 207 and the investment opportunity data posting module 306 may be configured to post one or more investment opportunity data sets 207 into the database 110. In some of these embodiments, an investment opportunity data solicit module 303 may solicit, without limitation, corporate formation information, business and financial information, and one or more investment offers 209 associated with the investment opportunity 207. In the present embodiment, an investor profile registration module 307 comprising an investor profile data solicit module 308 and an investor profile data posting module 309 receives and posts investor profile data 211 to the database 110. In many embodiments, the investor profile data solicit module 308 may be configured to receive one or more investor profile data sets 211 and the investor profile data posting module 309 may be configured to post one or more investor profile data sets 211 into the database 110. In some of these embodiments, an investor profile data solicit module 308 may solicit, without limitation, the investor's domicile territory, financial information, comprising, their individual and joint spouse net income, and their proposed investment amount or budget. In the present embodiment, a proposed bid data solicit module 310 may be configured to receive proposed bid data 212 and to pass said data set to a securities compliant bid validation module 313 for processing. In many embodiments, a bid validation module 314 would be configured to receive proposed bid data 212 from a proposed bid data solicit module 311. In some of these embodiments, the system may be further configured to retrieve investor profile data 211 from the database 110 to formulate proposed bid data 212. In the present embodiment, the bid validation module 314 may be configured to retrieve investment opportunity data 207, its governing regulatory rules 210, securities compliance qualifications data 203, and bidding history data 212 from the database 110 for the purpose of applying a plurality of application-specific bid validation algorithms to determine if proposed bid in an investment offer 209 would violate any securities thresholds 203 for the investment opportunity 207. In some embodiments, the bid validation 314 may result from a plurality of application-specific matching algorithms. In some of these embodiments, bid validation 314 may adhere to each of federal and/or state securities compliance thresholds 203. In one or more of these embodiments, bid validation 314 may be subject to one or more thresholds 203, whereas each threshold 203 is representative of a maximum value for securities exemption qualification under federal and/or state rules. In many of these embodiments, a bid validation display module 315 may be configured to display the validation results of the bid validation module 313.

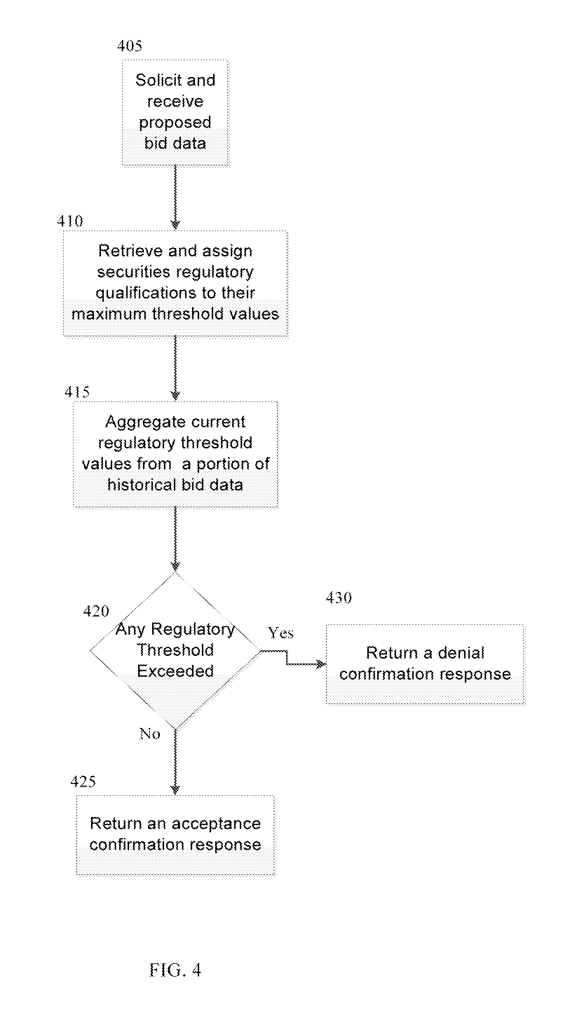

FIG. 4 is an illustration of an exemplary method for implementing a securities compliant bid validation system 106, in accordance with an embodiment of the present invention. In the present embodiment, system may solicit and receive proposed bid data comprising a unique investment offer identifier and a proposed user bid amount from a data source in a step 405. In many embodiments, system may retrieve and assign a set of one or more securities regulatory data attributes to their maximum threshold values 203 associated with the investment opportunity 207 in a step 410. In many embodiments, system may aggregate current regulatory threshold values from at least a portion of historical bid data 212 in a step 415. In some embodiments, system may aggregate current exemption qualifications threshold values from at least a portion of historical bid data 212 with newly proposed investment bid data, to assess if proposed investment would exceed any regulatory thresholds limits 204 for an associated investment opportunity 207 in a step 420. In a non-limiting example, a system may determine whether including a new investor would exceed a maximum number of allowed non-accredited investors for a threshold requirement. In the present embodiment, if no threshold is exceeded in step 420, system may return an acceptance confirmation response in a step 425, and if one or more regulatory thresholds 203 are exceeded in step 420, system may return a denial confirmation response in a step 430.

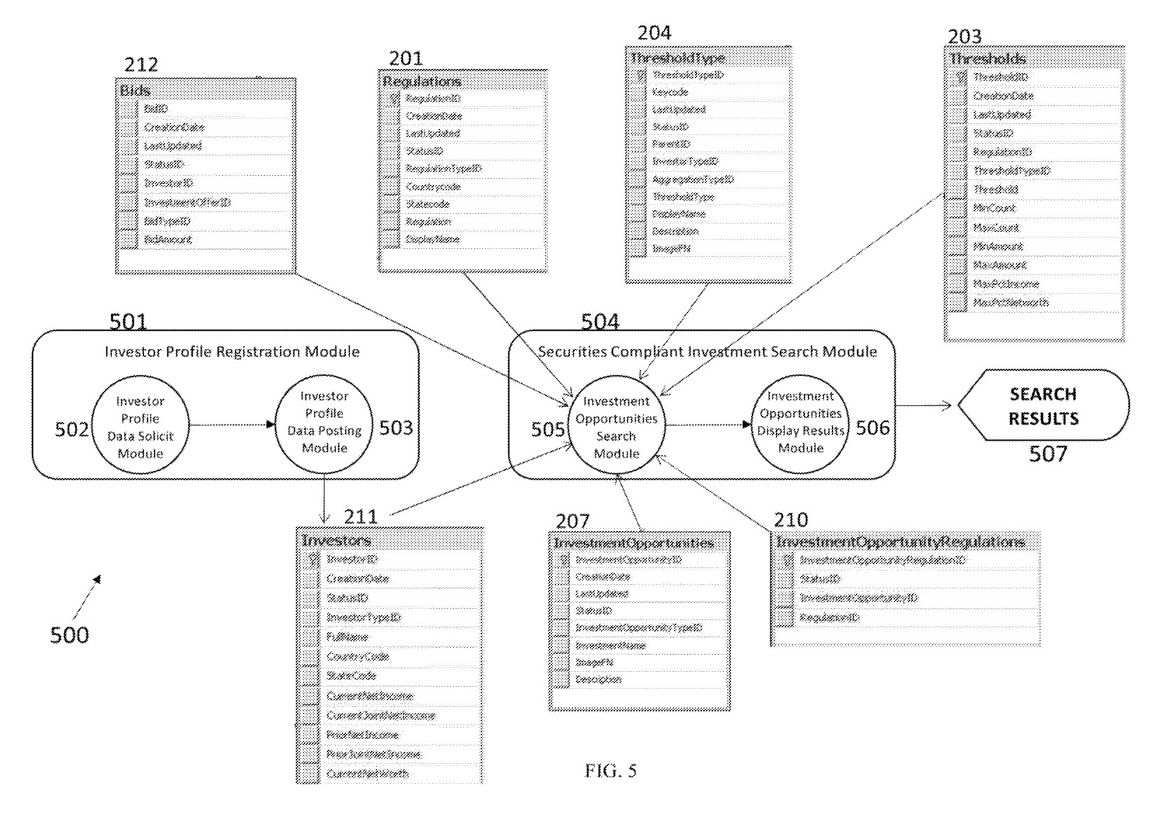

FIG. 5 is an illustration of an exemplary system for implementing securities compliant search and matching 500, in accordance with an embodiment of the present invention. In the present embodiment, a search data solicit module 502 may be configured to receive investor profile data 211 and to pass said data set to a securities compliant search and matching module 504 for processing. In many embodiments, a search and matching module 505 would be to retrieve investor profile data 211 from the database 110. In each of these embodiments, the search and matching module 505 may be further configured to retrieve investment opportunity data 207, associated governing regulatory qualification data 210, and invest opportunity bidding history data 212 from the database 110 for the purpose of applying one or more search and matching algorithms for retrieving a list investment opportunities 207 wherein an investment from the investor 211 would not violate a securities regulatory threshold requirement 203, and displaying said investment opportunities 207 as search results 507. In some embodiments, search results 507 may result from a plurality of application-specific matching algorithms. In some of these embodiments, search results 507 may adhere to each of federal and/or state securities compliant thresholds 203. In one or more of these embodiments, search results 507 may be subject to one or more thresholds, whereas each threshold is representative of a maximum value for exemption qualification under federal and/or state rules. In many of these embodiments, a display search results module 506 may be configured to display the search results 507.

In the present embodiment, system may have a processing unit 105 which may be suitable to implement a search and matching engine which may be configured to, without limitation: obtain information comprising a user profile 211, investment opportunities 207, and bidding history 212 on said investment opportunities 201; computationally aggregate user profile data 206 with at least a portion of historical bidding information 212 on said investment opportunity 207; match investor data 211 with one or more plurality of application-specific matching algorithms which may be associated with one or more thresholds for one or more of investment opportunities 201, wherein an investment bid indicated in investor data 206 may not constitute a violation of any federal and/or state exemption thresholds 203; and return results set 310 of matched investment opportunities 208 to a calling program, wherein results set 310 may have one or more conditions for investment, such as, without limitation, a maximum allowed investment. In some embodiments, processing unit 105 may be further configured to, without limitation, obtain current location information for users and default a domicile state in user profile data 206 with current location of system user. In one embodiment, system may incorporate a module suitable for displaying a screen set soliciting a set of profile data, inputting a set of input data, and passing input data to matching system. In some embodiments, system may utilize any suitable type of computer application, including, without limitation web applications and mobile applications.

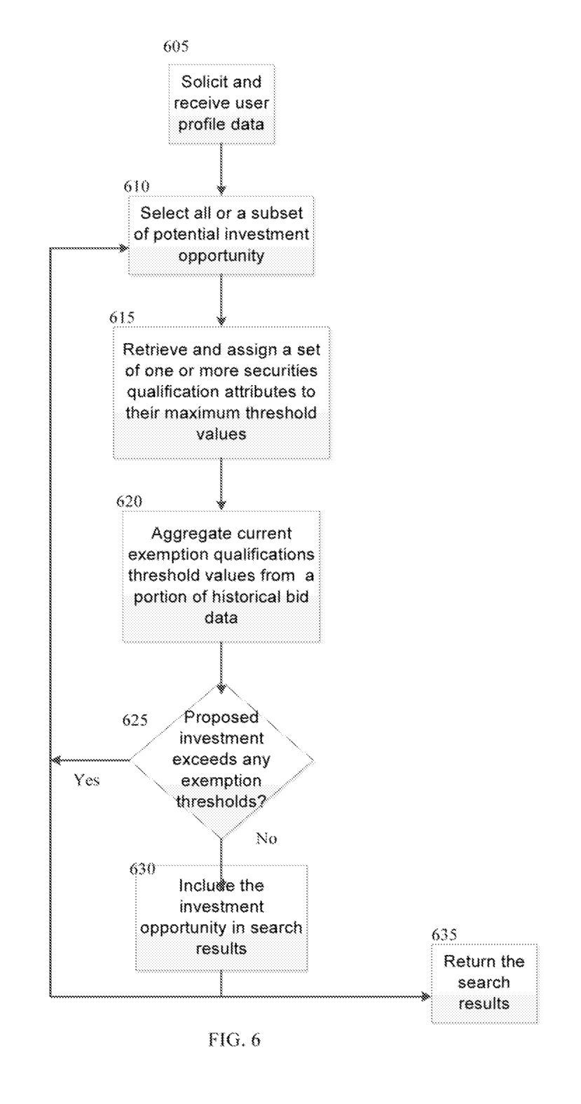

FIG. 6 is an illustration of an exemplary method for implementing a securities exemptions compliance search and matching system 106, in accordance with an embodiment of the present invention. In the present embodiment, system may solicit and receive user profile data 211 from a data source in a step 605. In many embodiments, the system may select all or a subset of potential investment opportunity 207 from a database 110 in a step 610. In a non-limiting example, an investment opportunity selection may exclude any user 211 not having a particular territorial jurisdiction (e.g. state) as specified in their user profile data 206 if accepting an investment from such user 211 would violate an investment opportunity's 207 securities threshold requirements 203. In many embodiments, system may retrieve and assign a set of one or more securities qualification attributes to their maximum threshold values 203 associated with the investment opportunity 207 in a step 615. In many embodiments, system may aggregate current exemption qualifications threshold values from at least a portion of historical bid data 212 in a step 620. In some embodiments, system may aggregate current exemption qualifications threshold values from at least a portion of historical bid data 212 with new proposed threshold data fields in user profile data 211 to assess if proposed investment would exceed any exemption thresholds 203 on existing regulatory thresholds 203 for an associated investment opportunity 207 in step 620. In a non-limiting example, a system may determine whether including a new investor would exceed a maximum number of allowed non-accredited investors for a regulatory threshold requirement. In the present embodiment, if no threshold is exceeded in a step 625 the system may include the investment opportunity 207 in search results set in a step 630. In some embodiments, following inclusion or a non-inclusion of a investment opportunity 207 in a result set, system may return to step 610. In the present embodiment, if the end of the selected investment opportunity list has been reach, system may return the search results set in a step 635.

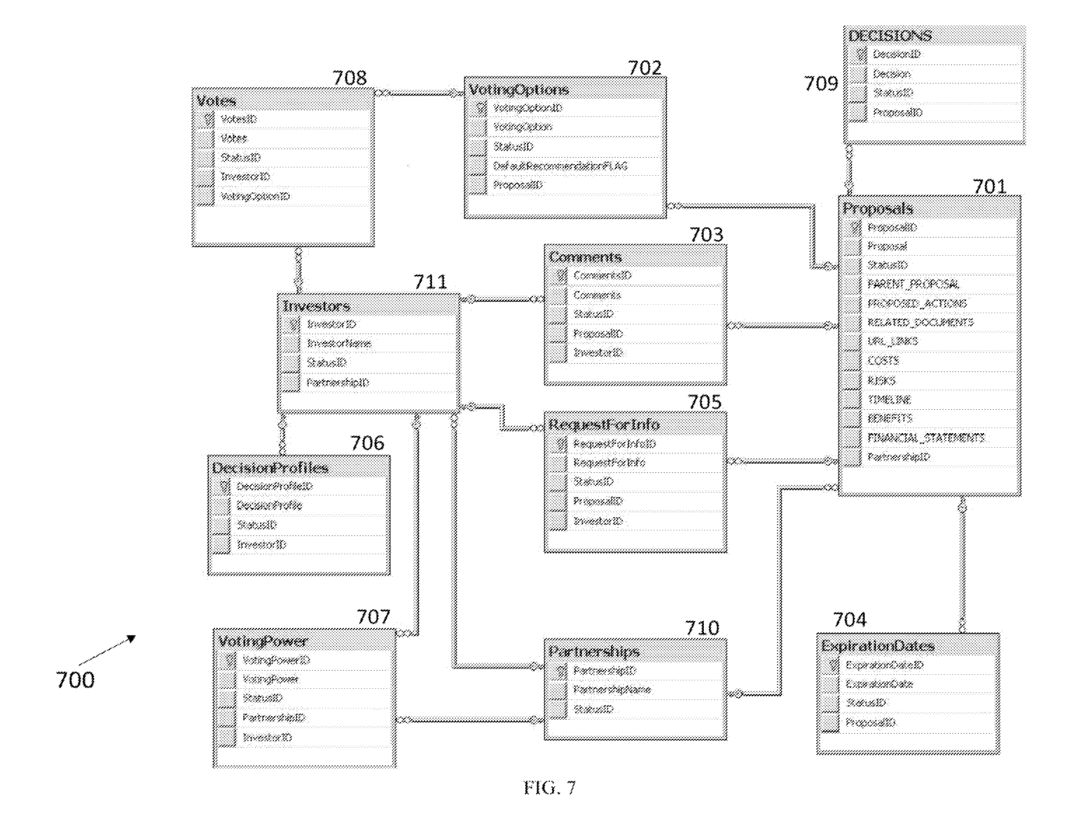

FIG. 7 is an illustration of an exemplary logical data model of a securities compliant active participation system 108, in accordance with an embodiment of the present invention. In the present embodiment, a logical data model 700 may include, without limitation, proposals 701 related to management and/or investment related issues or needed decision making pertaining to operating a partnership investment opportunity 710, proposal or voting options 702, expiration dates 704, comments 703, requests for info 705, investors or investors 711, decision profiles 706, voting power 707, votes 708, and final decisions 709 made on said proposals 701. In the present embodiment, proposal 701 comprises a summary of the issue or decision to be made by the partnership, a direct question suitable for receiving a voting response, any supporting documents useful in making an informed decision, proposal or voting options 702 to the proposal, and the expiration date 704 for voting on the proposal 701 by investors 711. In some embodiments, Request for Information 705 would represent requests from investors for more specific information to aid in formulating a voting response. In some embodiments, comments 703 would represent investor feedback or opinions on the proposal. In some of these embodiments, comments 703 may be published as a blog on a website. In the present embodiment, decision profiles 706 represent investor preferences on future issues that may arise to formulate an automatic or default decision on an issue once it arises. In many embodiments, voting power 707 represents the relative voting weight an investor has in relation to the other voting investors 711 in the partnership 710. In many embodiments, votes 708 are the actual set of voting options 702 selected by investors 711 in response to a proposal 701. In these embodiments, a decision 709 would be formulated by calculating the highest weighted average voting option 702 for a proposal 701.

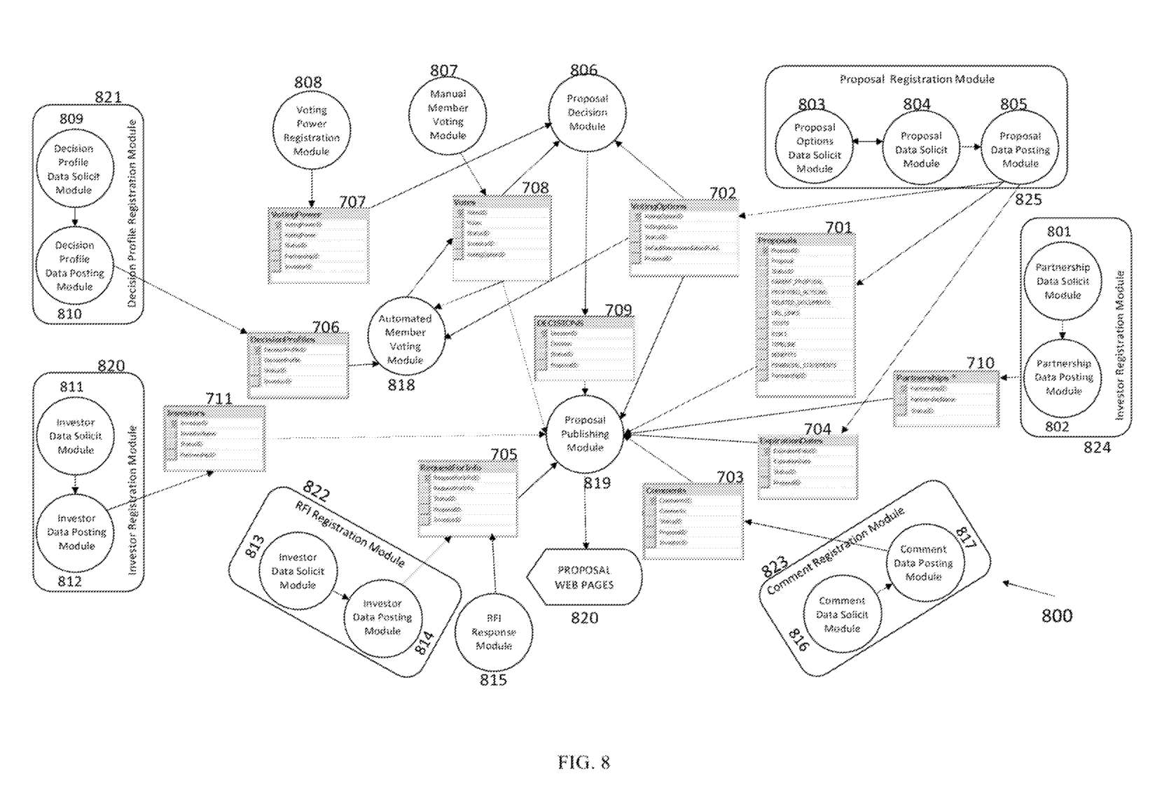

FIG. 8 is an illustration of an exemplary system for automating active participation 108 in an investor-managed partnership corporation 710, in accordance with an embodiment of the present invention. In the present embodiment, users are investors 711 of a corporation who actively participate in decision-making and other communications through use of internet 101 or other distributed communication network. In some embodiments, investors 711 may access internet 101 through use of any suitable device, including, without limitation, desktop computer, laptop, tablet, smartphone, etc. In one embodiment, one or more investors 711 may be designated as leaders during communications between investors 711. In the present embodiment, system may have a server 105. In many embodiments, server may comprise a database 110 which may store information pertaining to a partnership 710 and their investors 711 comprising proposals 701 from one or more investors 711, each investor's individual voting power 707, votes 708 on proposals 701, and proposal decisions 709. In the present embodiment, system may have one or more application modules comprising a partnership registration module 824, an investors/investors registration module 820, an investor's decision profile registration module 821, a proposal registration module 825, a proposal publishing module 819, a request for information registration module 822, a request for information response module 815, and a comment registration module 823, a voting power registration module 808, a manual investor voting module 807, and automated investor voting module 818, and a proposal decision module 806. In the present embodiment, a partnership registration module 824, comprising a partnership data solicit module 801 and a partnership data posting module 802, receives and posts partnership data 710 to the database 110. In many embodiments, the partnership data solicit module 801 may be configured to receive one or more partnership data sets 710 and the partnership data posting module 802 may be configured to post one or more partnership data sets 710 into the database 110. In some of these embodiments, a partnership data solicit module 801 may solicit, without limitation, partnership corporate formation information. In the present embodiment, an investor or investor registration module 820, comprising an investor data solicit module 811 and an investor data posting module 812, receives and posts investor data 711 to the database 110. In many embodiments, the investor data solicit module 811 may be configured to receive one or more investor data sets 711 and the investor data posting module 812 may be configured to post one or more investor data sets 711 into the database 110. In some of these embodiments, an investor data solicit module 811 may solicit, without limitation, investor login credentials and investor information. In some embodiments, a decision profile registration module 821, comprising a decision profile data solicit module 809 and a decision profile data posting module 810, receives and posts decision profile data 706 to the database 110. In these embodiments, the decision profile data solicit module 809 may be configured to receive one or more decision profile data sets 706 and the decision profile data posting module 810 may be configured to post one or more decision profile data sets 706 into the database 110. In some of these embodiments, a decision profile data solicit module 809 may solicit, without limitation, decision preferences of an investor pertaining to potentially future proposal voting decisions. In many embodiments, a proposal registration module 825, comprising a proposal data solicit module 804 and a proposal data posting module 805, receives and posts proposal data 701 to the database 110. In some of these embodiments, system may contain a proposal options data solicit module 803 for soliciting and receiving proposal or voting options data 702. In many embodiments, the proposal data solicit module 804 may be configured to receive one or more proposal data sets 701 and the proposal data posting module 805 may be configured to post one or more proposal data sets 701 into the database 110. In some embodiments, a proposal data solicit module 809 may solicit, without limitation, proposal information 701 explaining the issue or decision to be voted upon by the investors 711, the proposal voting options 702, and information establishing the open voting period or expiration date 704 time for voting. In some embodiments, a comment registration module 823, comprising a comment data solicit module 816 and a comment data posting module 817, receives and posts comment data 703 to the database 110. In many embodiments, the comment data solicit module 816 may be configured to receive one or more comment data sets 703 and the comment data posting module 817 may be configured to post one or more comment data sets 703 into the database 110. In some embodiments, a comment data solicit module 809 may solicit, without limitation, comments 703 on a proposal 701. In some embodiments, a request for information registration module 822, comprising a request for information data solicit module 813 and a request for information data posting module 814, receives and posts request for information data 705 to the database 110. In many embodiments, the request for information data solicit module 813 may be configured to receive one or more request for information data sets 705 and the request for information data posting module 814 may be configured to post one or more request for information data sets 705 into the database 110. In some embodiments, a request for information data solicit module 813 may solicit, without limitation, request for additional information 705 pertaining to a proposal 701. In some embodiments, a request for information response module 815 may be configured to solicit, receive, and post request for information data sets 705 to a database 110 in response to a previous request for information 705. In the present embodiment, system may contain a proposal publishing module 819 configured to retrieve with all information pertaining to a proposal, including, but not limiting, proposal information 701, voting options 702, voting expiration date 704, proposal comments 703, request for information 705, and voting data 708, and to publish said sets of data to one or more web pages 820 hosted on a web server 105. In many embodiments, system may contain a voting power registration system 808 for calculating and assigning voting power values 707 to investors 711 based on a plurality of application-specific voting power assignment algorithms and storing voting power 707 values for each investor 711 in a database 110. In many embodiments, system may contain a manual investor voting module 807 for soliciting, receiving, and posting a voting option choice 702 on a proposal 701 from an investor 711 into a database 110. In the present embodiment, system may contain an automated investor voting module 818 that considers an investor's decision profile data 706 and automatically assigns a proposal vote 708 for an investor 711 and stores the assigned voting option 708 in a database 110. In the present embodiment, system may contain a proposal decision module 806 configured to read all investor 711 votes 708 on a proposal 701 and their voting power 707, and to apply a plurality of application specific decision determination logic to derive the highest weighted voting option on a proposal 701 formulating a decision 709, and to store said decision in a database 110. In some embodiments, one of the voting options 702 on a proposal 701 may be designated as the default vote representing an investor's election of a no response vote on a proposal 701. In some embodiments, occurrence of the expiration data may trigger the execution of the automated investor voting module 818. Further, in some embodiments, an application module 108 may be suitable for notifying and/or soliciting votes on a proposal 701 from investors 711.

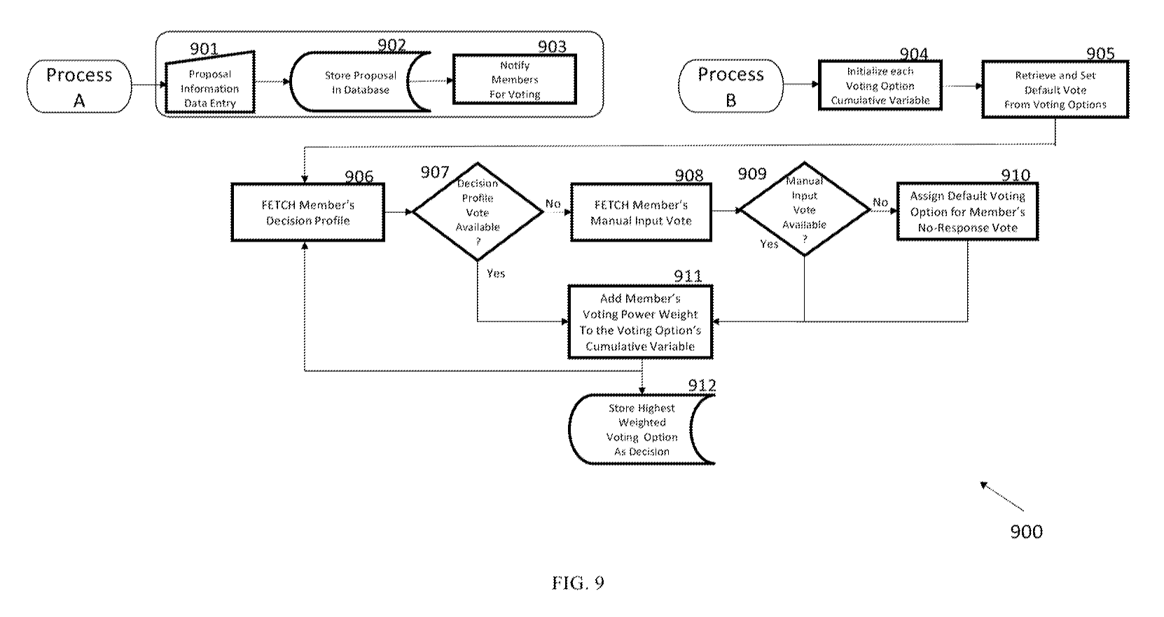

FIG. 9 is an illustration of an exemplary method for implementing an active participation system, in accordance with an embodiment of the present invention. In the present embodiment, a lead investor may input proposal information in a step 901. In the present embodiment, system may store proposal data in a database 110 in a step 902. Further, in the present embodiment, system may notify voting investors 711 of proposal to initiate a voting process in a step 903. In some embodiments, lead-investor may set a date for the expiration of the voting period. In many of these embodiments, system may begin the process of formulating a decision 709 on the proposal 701 upon the expiration of the voting period 704. In some embodiments, system may progress through a list of investors in any order. In the present embodiment, system may read an investor's decision profile 706 in step 906. In the present embodiment, system may determine whether investor's vote is available from the decision profile 706 in a step 907. Further, in the present embodiment, if investor's vote is not available in the decision profile 706, system may fetch an investor's manual vote in a step 908. In the present embodiment, system may determine whether investor's vote is available from the manual vote data set 708 in a step 909. Further, in the present embodiment, if investor's vote is not available in the manual vote data set 708, system may set investor's vote to the default recommendation no-response vote in a step 910. Steps 906 and 907 are interchangeable with steps 908 and 909. In some alternative embodiments, an investor may set personal default voting information. In a non-limiting example, a user may choose to default their vote to the same vote of another specified investor. In the present embodiment, if investor's vote is found to be available, or a no-response default vote has been entered for the investor, system may add investor's voting power weight 707 to a voting option cumulative variable in a step 911. In some embodiments, system may create a loop with a variable, e.g. X, representing a number of voting investors 711. In some of these embodiments, system may move from step 906 to 911 as many times as may be represented by X value so as to receive voting data for each investor. In the present embodiment, if end of list has been reached, system may assign a highest weighted voting option to a variable and store the highest weighted voting option, formulating a decision, in a database 110 in a step 912.

In some alternative embodiments, system may provide generic information to help users. In a non-limiting example, an exemplary internet web page may provide tutorial videos for investors on how to use the web page to effectively make investments within federal and/or state rules. In other alternative embodiments, system may have means for providing financial assistance to users. In a non-limiting example, a group of investors who may be a little short on reaching an amount of money may submit a request for a loan from system. In the present non-limiting example, system may internally provide a loan or reach out to third party lenders.

In other alternative embodiments, system may be suitable for allowing users to communicate via video chat. In some of these embodiments, system may have internal means for video chat. In other of these embodiments, system may work with a third party company which may provide video chat capability.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

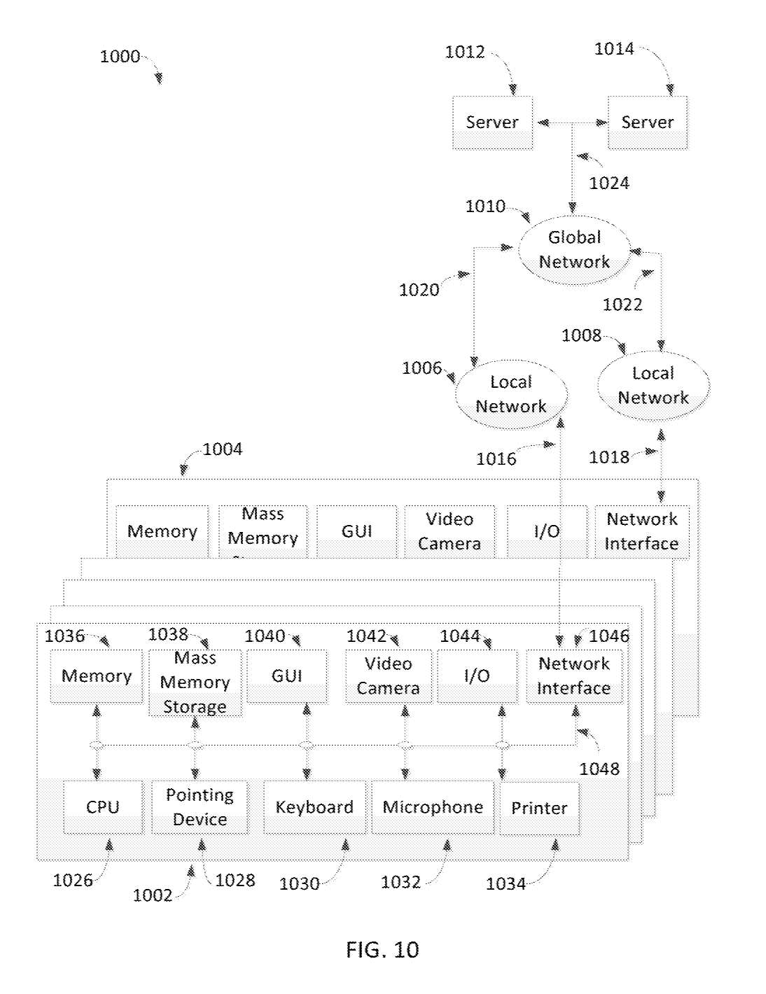

FIG. 10 is a block diagram depicting an exemplary client/server system which may be used by an exemplary web-enabled/networked embodiment of the present invention.

A communication system 1000 includes a multiplicity of clients with a sampling of clients denoted as a client 1002 and a client 1004, a multiplicity of local networks with a sampling of networks denoted as a local network 1006 and a local network 1008, a global network 1010 and a multiplicity of servers with a sampling of servers denoted as a server 1012 and a server 1014.

Client 1002 may communicate bi-directionally with local network 1006 via a communication channel 1016. Client 1004 may communicate bi-directionally with local network 1008 via a communication channel 1018. Local network 1006 may communicate bi-directionally with global network 1010 via a communication channel 1020. Local network 1008 may communicate bi-directionally with global network 1010 via a communication channel 1022. Global network 1010 may communicate bi-directionally with server 1012 and server 1014 via a communication channel 1024. Server 1012 and server 1014 may communicate bi-directionally with each other via communication channel 1024. Furthermore, clients 1002, 1004, local networks 1006, 1008, global network 1010 and servers 1012, 1014 may each communicate bi-directionally with each other.

In one embodiment, global network 1010 may operate as the Internet. It will be understood by those skilled in the art that communication system 1000 may take many different forms. Non-limiting examples of forms for communication system 1000 include local area networks (LANs), wide area networks (WANs), wired telephone networks, wireless networks, or any other network supporting data communication between respective entities.

Clients 1002 and 1004 may take many different forms. Non-limiting examples of clients 1002 and 1004 include personal computers, personal digital assistants (PDAs), cellular phones and smartphones.

Client 1002 includes a CPU 1026, a pointing device 1028, a keyboard 1030, a microphone 1032, a printer 1034, a memory 1036, a mass memory storage 1038, a GUI 1040, a video camera 1042, an input/output interface 1044 and a network interface 1046.

CPU 1026, pointing device 1028, keyboard 1030, microphone 1032, printer 1034, memory 1036, mass memory storage 1038, GUI 1040, video camera 1042, input/output interface 1044 and network interface 1046 may communicate in a unidirectional manner or a bi-directional manner with each other via a communication channel 1048. Communication channel 1048 may be configured as a single communication channel or a multiplicity of communication channels.

CPU 1026 may be comprised of a single processor or multiple processors. CPU 1026 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1036 is used typically to transfer data and instructions to CPU 1026 in a bi-directional manner. Memory 1036, as discussed previously, may include any suitable computer-readable media, intended for data storage, such as those described above excluding any wired or wireless transmissions unless specifically noted. Mass memory storage 1038 may also be coupled bi-directionally to CPU 1026 and provides additional data storage capacity and may include any of the computer-readable media described above. Mass memory storage 1038 may be used to store programs, data and the like and is typically a secondary storage medium such as a hard disk. It will be appreciated that the information retained within mass memory storage 1038, may, in appropriate cases, be incorporated in standard fashion as part of memory 1036 as virtual memory.

CPU 1026 may be coupled to GUI 1040. GUI 1040 enables a user to view the operation of computer operating system and software. CPU 1026 may be coupled to pointing device 1028. Non-limiting examples of pointing device 1028 include computer mouse, trackball and touchpad. Pointing device 1028 enables a user with the capability to maneuver a computer cursor about the viewing area of GUI 1040 and select areas or features in the viewing area of GUI 1040. CPU 1026 may be coupled to keyboard 1030. Keyboard 1030 enables a user with the capability to input alphanumeric textual information to CPU 1026. CPU 1026 may be coupled to microphone 1032. Microphone 1032 enables audio produced by a user to be recorded, processed and communicated by CPU 1026. CPU 1026 may be connected to printer 1034. Printer 1034 enables a user with the capability to print information to a sheet of paper. CPU 1026 may be connected to video camera 1042. Video camera 1042 enables video produced or captured by user to be recorded, processed and communicated by CPU 1026.

CPU 1026 may also be coupled to input/output interface 1044 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1026 optionally may be coupled to network interface 1046 which enables communication with an external device such as a database or a computer or telecommunications or internet network using an external connection shown generally as communication channel 1016, which may be implemented as a hardwired or wireless communications link using suitable conventional technologies. With such a connection, CPU 1026 might receive information from the network, or might output information to a network in the course of performing the method steps described in the teachings of the present invention.

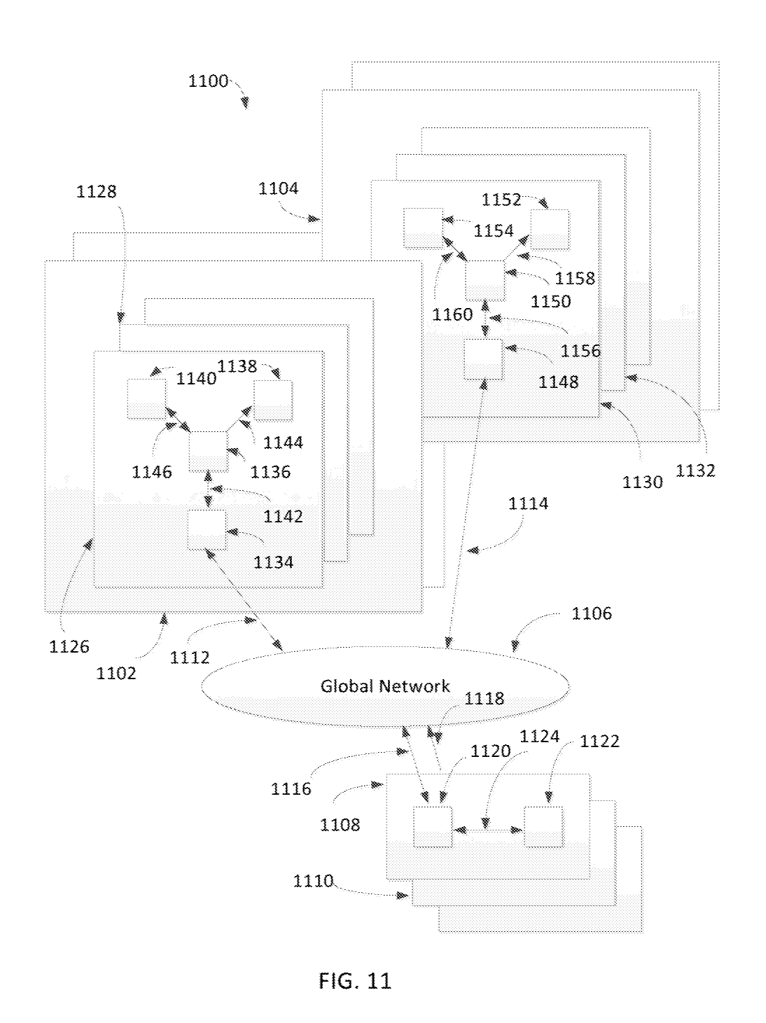

FIG. 11 illustrates a block diagram depicting a conventional client/server communication system.

A communication system 1100 includes a multiplicity of networked regions with a sampling of regions denoted as a network region 1102 and a network region 1104, a global network 1106 and a multiplicity of servers with a sampling of servers denoted as a server device 1108 and a server device 1111.

Network region 1102 and network region 1104 may operate to represent a network contained within a geographical area or region. Non-limiting examples of representations for the geographical areas for the networked regions may include postal zip codes, telephone area codes, states, counties, cities and countries. Elements within network region 1102 and 1104 may operate to communicate with external elements within other networked regions or within elements contained within the same network region.

In some implementations, global network 1106 may operate as the Internet. It will be understood by those skilled in the art that communication system 1100 may take many different forms. Non-limiting examples of forms for communication system 1100 include local area networks (LANs), wide area networks (WANs), wired telephone networks, cellular telephone networks or any other network supporting data communication between respective entities via hardwired or wireless communication networks. Global network 1106 may operate to transfer information between the various networked elements.

Server device 1108 and server device 1114 may operate to execute software instructions, store information, support database operations and communicate with other networked elements. Non-limiting examples of software and scripting languages which may be executed on server device 1108 and server device 1114 include C, C++, C# and Java.

Network region 1102 may operate to communicate bi-directionally with global network 1106 via a communication channel 1112. Network region 1104 may operate to communicate bi-directionally with global network 1106 via a communication channel 1114. Server device 1108 may operate to communicate bi-directionally with global network 1106 via a communication channel 1116. Server device 1114 may operate to communicate bi-directionally with global network 1106 via a communication channel 1118. Network region 1102 and 1104, global network 1106 and server devices 1108 and 1114 may operate to communicate with each other and with every other networked device located within communication system 1100.

Server device 1108 includes a networking device 1120 and a server 1122. Networking device 1120 may operate to communicate bi-directionally with global network 1106 via communication channel 1116 and with server 1122 via a communication channel 1124. Server 1122 may operate to execute software instructions and store information.

Network region 1102 includes a multiplicity of clients with a sampling denoted as a client 1126 and a client 1128. Client 1126 includes a networking device 1134, a processor 1136, a GUI 1138 and an interface device 1140. Non-limiting examples of devices for GUI 1138 include monitors, televisions, cellular telephones, smartphones and PDAs (Personal Digital Assistants). Non-limiting examples of interface device 1140 include pointing device, mouse, trackball, scanner and printer. Networking device 1134 may communicate bi-directionally with global network 1106 via communication channel 1112 and with processor 1136 via a communication channel 1142. GUI 1138 may receive information from processor 1136 via a communication channel 1144 for presentation to a user for viewing. Interface device 1140 may operate to send control information to processor 1136 and to receive information from processor 1136 via a communication channel 1146. Network region 1104 includes a multiplicity of clients with a sampling denoted as a client 1130 and a client 1132. Client 1130 includes a networking device 1148, a processor 1150, a GUI 1152 and an interface device 1154. Non-limiting examples of devices for GUI 1138 include monitors, televisions, cellular telephones, smartphones and PDAs (Personal Digital Assistants). Non-limiting examples of interface device 1140 include pointing devices, mousse, trackballs, scanners and printers. Networking device 1148 may communicate bi-directionally with global network 1106 via communication channel 1111 and with processor 1150 via a communication channel 1156. GUI 1152 may receive information from processor 1150 via a communication channel 1158 for presentation to a user for viewing. Interface device 1154 may operate to send control information to processor 1150 and to receive information from processor 1150 via a communication channel 1160.

For example, consider the case where a user interfacing with client 1126 may want to execute a networked application. A user may enter the IP (Internet Protocol) address for the networked application using interface device 1140. The IP address information may be communicated to processor 1136 via communication channel 1146. Processor 1136 may then communicate the IP address information to networking device 1134 via communication channel 1142. Networking device 1134 may then communicate the IP address information to global network 1106 via communication channel 1112. Global network 1106 may then communicate the IP address information to networking device 1120 of server device 1108 via communication channel 1116. Networking device 1120 may then communicate the IP address information to server 1122 via communication channel 1124. Server 1122 may receive the IP address information and after processing the IP address information may communicate return information to networking device 1120 via communication channel 1124. Networking device 1120 may communicate the return information to global network 1106 via communication channel 1116. Global network 1106 may communicate the return information to networking device 1134 via communication channel 1112. Networking device 1134 may communicate the return information to processor 1136 via communication channel 1142. Processor 1146 may communicate the return information to GUI 1138 via communication channel 1144. User may then view the return information on GUI 1138.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing buying and selling investments according to the present invention will be apparent to those skilled in the art. Various aspects of the invention have been described above by way of illustration, and the specific embodiments disclosed are not intended to limit the invention to the particular forms disclosed. The particular implementation of the buying and selling investments may vary depending upon the particular context or application. By way of example, and not limitation, the buying and selling investments described in the foregoing were principally directed to securities compliant implementations; however, similar techniques may instead be applied to adherence to any rules or regulations, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
receiving a proposal from a lead investor of an investor-managed partnership corporation, said proposal being received over a network communication system, said proposal at least comprising voting options;
storing said proposal in a database of a securities compliant active participation system;
communicating said receipt of said proposal to voting investors of said investor-managed partnership corporation for initiating a voting process;
receiving voting data for each of said voting investors;
adding a voting power weight of each of said voting investors to voting data in a cumulative manner for each of said voting options; and
storing a highest weighted cumulative voting option as a decision.

2. The method as recited in claim 1, further comprising the steps of:
soliciting a plurality of investment offers;
receiving a proposed bid, for at least one of said investment offers, from a passive and/or active investor, said proposed bid data being received over a network communication system, said proposed bid data at least comprising a unique investment offer identifier identifying said investment offer and a proposed user bid amount;
retrieving securities regulatory qualifications for said investment offer;
assigning said securities regulatory qualifications to their maximum threshold values;
aggregating current regulatory threshold values from at least a portion of historical bid data for said investment offer;
determining if said proposed bid would exceed any of said assigned thresholds;
returning a denial confirmation upon said determining an exceeding of any said assigned thresholds; and
returning an acceptance confirmation upon absence of exceeding of any said assigned thresholds.

3. The method as recited in claim 1, further comprising the steps of:
receiving a search request from an investor, said search request being received over a network communication system, said search request at least comprising a request to view investment offers;
retrieving securities regulatory qualifications for an investment offer;
assigning said securities regulatory qualifications to their maximum threshold values;
aggregating current regulatory threshold values from at least a portion of historical bid data for said investment offer;
determining if a bid from said investor would exceed any of said assigned thresholds; and
including said investment offer in a search results for said investor upon absence of exceeding of any said assigned thresholds.

4. The method as recited in claim 1, in which said proposal further comprises an expiration of a voting period.

5. The method as recited in claim 1, in which voting data is retrieved from a decision profile for a one of said voting investors.

6. The method as recited in claim 5, in which retrieved voting data comprises a default recommendation for a no-response vote.

7. The method as recited in claim 2, in which said proposed bid further comprises profile information for said investor.

8. The method as recited in claim 7, in which said profile information comprises domicile territory and investor financial data elements.

9. The method as recited in claim 3, in which said search request further comprises profile information for said investor.

10. A method comprising:
steps for receiving a proposal from a lead investor of an investor-managed partnership corporation;
step for storing said proposal;
steps for communicating said receipt of said proposal for initiating a voting process;
steps for receiving voting data;
steps for weighting said voting data; and
steps for storing a decision.

11. The method as recited in claim 10, further comprising:
steps for soliciting investment offers;
steps for receiving a proposed bid;
steps for retrieving securities regulatory qualifications;
steps for assigning maximum threshold values;
steps for aggregating current regulatory threshold values;
steps for determining if said proposed bid would exceed any of said assigned thresholds;
steps for returning a denial confirmation upon said determining an exceeding of any said assigned thresholds;
steps for returning an acceptance confirmation upon absence of exceeding of any said assigned thresholds;
steps for receiving a search request from an investor;
steps for retrieving securities regulatory qualifications for an investment offer;
steps for assigning maximum threshold values for said investment offer;
steps for aggregating current regulatory threshold values for said investment offer;
steps for determining if a bid from said investor would exceed any of said assigned thresholds; and
steps for including said investment offer in a search results for said investor upon absence of exceeding of any said assigned thresholds.

12. A non-transitory computer-readable storage medium with an executable program stored thereon, wherein the program instructs one or more processors to perform the following steps:
receiving a proposal from a lead investor of an investor-managed partnership corporation, said proposal being received over a network communication system, said proposal at least comprising voting options;
storing said proposal in a database of a securities compliant active participation system;
communicating said receipt of said proposal to voting investors of said investor-managed partnership corporation for initiating a voting process;
receiving voting data for each of said voting investors;
adding a voting power weight of each of said voting investors to voting data in a cumulative manner for each of said voting options; and
storing a highest weighted cumulative voting option as a decision.

13. The program instructing the one or more processors as recited in claim 12, further comprising the steps of:
soliciting a plurality of investment offers;
receiving a proposed bid, for at least one of said investment offers, from a passive and/or active investor, said proposed bid data being received over a network communication system, said proposed bid data at least comprising a unique investment offer identifier identifying said investment offer and a proposed user bid amount;
retrieving securities regulatory qualifications for said investment offer;
assigning said securities regulatory qualifications to their maximum threshold values;
aggregating current regulatory threshold values from at least a portion of historical bid data for said investment offer;
determining if said proposed bid would exceed any of said assigned thresholds;
returning a denial confirmation upon said determining an exceeding of any said assigned thresholds; and
returning an acceptance confirmation upon absence of exceeding of any said assigned thresholds.

14. The program instructing the one or more processors as recited in claim 12, further comprising the steps of:
receiving a search request from an investor, said search request being received over a network communication system, said search request at least comprising a request to view investment offers;
retrieving securities regulatory qualifications for an investment offer;
assigning said securities regulatory qualifications to their maximum threshold values;
aggregating current regulatory threshold values from at least a portion of historical bid data for said investment offer;
determining if a bid from said investor would exceed any of said assigned thresholds; and
including said investment offer in a search results for said investor upon absence of exceeding of any said assigned thresholds.

15. The program instructing the one or more processors as recited in claim 12, in which said proposal further comprises an expiration of a voting period.

16. The program instructing the one or more processors as recited in claim 12, in which voting data is retrieved from a decision profile for a one of said voting investors.

17. The program instructing the one or more processors as recited in claim 16, in which retrieved voting data comprises a default recommendation for a no-response vote.

18. The program instructing the one or more processors as recited in claim 13, in which said proposed bid further comprises profile information for said investor.

19. The program instructing the one or more processors as recited in claim 18, in which said profile information comprises domicile territory and investor financial data elements.

20. The program instructing the one or more processors as recited in claim 14, in which said search request further comprises profile information for said investor.
